(19) United States
(12) Patent Application Publication
(10) Pub. No.: US 2026/0253857 A1
(43) Pub. Date: Aug. 27, 2026

(54) APPARATUS AND METHOD

(71) Applicant: Isotopx Ltd, Middlewich, Cheshire (GB)

(72) Inventors: Matt HOCKLEY, Middlewich, Cheshire (GB); Zenon PALACZ, Middlewich, Cheshire (GB); Anthony Michael JONES, Middlewich, Cheshire (GB)

(21) Appl. No.: 18/577,339

(22) PCT Filed: Jul. 12, 2022
(86) PCT No.: PCT/GB2022/051797

§ 371 Date: Jan. 8, 2024

(30) Foreign Application Priority Data
Jul. 13, 2021 (GB) 2110060.7

(51) Int. Cl. H01J 49/06; H01J 49/42

(52) U.S. Cl. CPC H01J 49/063; H01J 49/066; H01J 49/421; H01J 49/426

(57) ABSTRACT

An ion guide assembly for a mass spectrometer is described. The ion guide assembly comprises a collision/reaction cell, CRC, comprising an enclosure having a first multipole RF ion guide enclosed radially therein and a set of gas inlets, including a first gas inlet, therethrough; and a first ion energy filter disposed upstream of the CRC, to prevent ions having an ion energy below a first predetermined threshold from entering the CRC.

### FIELD

The present invention relates to collision/reaction cells, CRCs, for mass spectrometers.

### BACKGROUND TO THE INVENTION

Generally, collision/reaction cells, CRCs, are used to thermalize ions of interest and/or remove interfering ions through ion/neutral reactions before mass spectrometry of the ions of interest. Typically, a CRC comprises an enclosure having a multipole RF ion guide enclosed radially therein and a set of gas inlets, including a first gas inlet, therethrough. Collisional gases such as He or Ar and/or reactive gases such as H2, NH4, CH4 or O2 are introduced into the enclosure via the set of gas inlets. Ions are guided axially through the multipole RF ion guide and collide and/or react with the introduced gases. Collisional gases are primarily used to attenuate and normalize the axial kinetic energies of the ions (also known as thermalizing, collisional energy damping and/or collisional focusing) but may also secondarily react with some of the ions. Reactive gases are primarily used to remove isobaric interferences through ion/neutral reactions, for example by changing mass-to-charge ratios of the interfering ions away from mass-to-charge ratios of ions of interest. Hence, CRCs may generally be used as collision cells, reaction cells and/or collision/reaction cells, depending on the gases introduced therein and thus be named according to primary use, for example. CRCs are included in inorganic mass spectrometers such as commercial inductively coupled plasma mass spectrometers (ICP-MS), such as the Micromass (RTM) hexapole collision cell, the Perkin Elmer (RTM) Dynamic Reaction Cell (RTM), the Agilent (RTM) Octopole Reaction System (ORS) and the Thermo Fisher Scientific (RTM) Collision Cell Technology. Other CRCs are known. CRCs are also included in organic mass spectrometers such electrospray tandem quadrupole mass spectrometers.

However, there remains a need to improve CRCs.

### SUMMARY OF THE INVENTION

It is one aim of the present invention, amongst others, to provide an ion guide assembly which at least partially obviates or mitigates at least some of the disadvantages of the prior art, whether identified herein or elsewhere. For instance, it is an aim of embodiments of the invention to provide an ion guide assembly that improves removal of interfering ions.

A first aspect provides an ion guide assembly for a mass spectrometer, the ion guide assembly comprising:
a collision/reaction cell, CRC, comprising an enclosure having a first multipole RF ion guide enclosed radially therein and a set of gas inlets, including a first gas inlet, therethrough; and a first ion energy filter disposed upstream of the CRC, to prevent ions having an ion energy below a first predetermined threshold from entering the CRC.

A second aspect provides a mass spectrometer comprising an ion guide assembly according to the first aspect.

A third aspect provides a method of controlling interferences in a mass spectrometer comprising a collision/reaction cell, CRC, the method comprising:

preventing ions having an ion energy below a first predetermined threshold from entering the CRC.

### DETAILED DESCRIPTION OF THE INVENTION

According to the present invention there is provided an ion guide assembly, as set forth in the appended claims. Also provided is a mass spectrometer and a method. Other features of the invention will be apparent from the dependent claims, and the description that follows.

### Ion Guide Assembly

A first aspect provides an ion guide assembly for a mass spectrometer, the ion guide assembly comprising:
a collision/reaction cell, CRC, comprising an enclosure having a first multipole RF ion guide enclosed radially therein and a set of gas inlets, including a first gas inlet, therethrough; and a first ion energy filter disposed upstream of the CRC, to prevent ions having an ion energy below a first predetermined threshold from entering the CRC.

In this way, the CRC is improved, for example by removing interfering ions, by preventing back-streaming of ions of interest and/or by reducing effects due to Ar ions from ICP sources, for example.

Firstly, in this way, ions, for example interfering ions, having ion energies (i.e. axial kinetic energies) below the first predetermined threshold are prevented from entering the CRC by the first ion energy filter, thereby reducing or eliminating isobaric interferences due thereto and hence improving sensitivity of ions of interest. Particularly, the inventors have determined that some interfering ions are formed having relatively lower ion energies than the ion energies of the ions of interest. Hence, these interfering ions, having relatively lower ion energies, are preferentially filtered (i.e. discriminated) by the first ion energy filter while the ions of interest, having ion energies of at least the first predetermined threshold, are admitted into the CRC. Since the CRC may attenuate and normalize the ion energies of both the ions of interest and the interfering ions, thereby reducing a relative difference between their respective ion energies, the first ion energy filter is disposed upstream (i.e. before) the CRC, so as to exploit the relative difference between the respective ion energies of the ions of interest and the interfering ions. By way of example, hydrocarbon ions generated in the ion source from vacuum pump oils may be prevented from entering and hence passing through the CRC by the first ion energy filter thereby reducing or eliminating isobaric interferences caused thereby. Generally, collision cells suffer from the issue that any ions that enter the cells will be transmitted therethrough, even if these ions are not desirable, such as interfering ions. One method of removing these ions is to use reactive gasses to “mass shift” the undesired ions away from the mass-to-charge ratios of interest, or to neutralize the ion by charge transfer. This is not possible with all ions, such as due to hydrocarbons present in the oils of wet (e.g. oil rotary vane) vacuum pumps, which are ionized in the source of an ICP-MS due to gas back-streaming, for example. Such hydrocarbon ions may be present over a very wide mass-to-charge range, so mass shifting is not effective, as other hydrocarbon ions may also be shifted into to the mass-to-charge ratios of those initially shifted. These hydrocarbon ions result in isobaric interferences on analyte beams (i.e. ions of interest), and are not readily corrected by usual methods of interference correction. This results in degradation of data quality, particularly sensitivity (defined as signal to noise ratio i.e. S:N). A method used to address this particular hydrocarbon issue is to use dry (e.g. diaphragm) vacuum pumps, which is expensive and only partially effective, while also reducing instrument reliability, and increasing running costs.

The ion guide assembly according to the first aspect addresses this issue of the presence of hydrocarbon ions in the mass spectrum, for example for an ICP-MS. The inventors have determined that the energy of an ion in the source of an ICP-MS is determined by where in the source the ion is formed and its mass. Hydrocarbon ions may have similar mass-to-charge ratios to the mass-to-charge ratios of ions of interest, so cannot be removed by mass analysis. However, the inventors have determined that these hydrocarbon ions have relatively lower energies due to the hydrocarbons being ionized later in the sample introduction process. This energy difference, between the ions of interest and the hydrocarbon ions, is exploited to preferentially remove the relatively low energy hydrocarbons while allowing passage of the relatively higher energy ions of interest (‘the main beam’), effectively removing the hydrocarbon based isobaric interferences that particularly affect measurements of isotope ions of interest in the mass-to-charge ratio range from 200 to 300.

Secondly, in this way, ions of interest admitted into the CRC and thermalized therein, thereby having ion energies (i.e. axial kinetic energies) reduced to below the first predetermined threshold, are prevented from back-streaming from the CRC by the first ion energy filter, thereby increasing a signal due thereto. Particularly, increasing the ion flux from the source may not result in higher signals for conventional CRCs since some ions thermalized in the CRC backstream out of the CRC, towards the source (i.e. upstream), rather than move downstream out of the CRC. In contrast, the first ion energy filter prevents these ions, having ion energies reduced to below the first predetermined threshold by the CRC, from back-streaming. Hence, the first ion energy filter confines these ions axially while the CRC confines the ions radially such that these ions exit only downstream from the CRC.

In other words, once the ion energies of the ions of interest are reduced by the CRC, these the ions of interest may not pass back through the entrance due to the potential barrier of the first ion energy filter, and may not exit radially due to the trapping potential of the first RF multipole ion guide, so these ions of interest must exit via the desired end of the CRC, preventing beam loss in highly thermalized beams.

Thirdly, in this way, Ar ions from ICP sources may be removed by the first ion energy filter. This is particularly beneficial for mass spectrometry of species heavier than Ar, since energy of ions produced in the source increases with mass due to a mass dependence of energy gained during gas expansion into the vacuum, so these heavier ions will be preferentially transmitted. In more detail, space charge effects caused by a large Ar ion beam have a mass dependent effect on ions of interest, thereby both reducing transmission of the ions of interest, and increasing undesirable mass dependent transmission effects. By filtering out the Ar ions, having relatively lower ion energies than the ions of interest, using the first ion energy filter, transmission of the ions of interest is increased, and undesirable mass dependent transmission effects mitigated and/or eliminated.

### Mass Spectrometer

The ion guide assembly is for a mass spectrometer, for example as described with respect to the second aspect.

### CRC

The ion guide assembly comprises the CRC. CRCs are known.

The CRC comprises the enclosure having the first multipole RF ion guide enclosed radially therein and the set of gas inlets, including the first gas inlet, therethrough. It should be understood that the enclosure radially surrounds the first multipole RF ion guide. For example, the enclosure may comprise or be a pipe or cylinder having open ends or respective apertures in ends thereof, providing an entrance and an exit for the ions. It should be understood that the ion guide assembly is arranged in a vacuum chamber of the mass spectrometer, maintained at a sufficiently low pressure by a vacuum pump, for example a turbomolecular pump. Since the vacuum chamber is pumped continuously by the vacuum pump and since the enclosure has open ends or apertures, gas is typically introduced into the enclosure via the set of gas inlets continuously during mass spectrometry at a flow rate sufficient to provide a sufficiently high pressure of the gas in the enclosure for collision and/or reaction with the ions while the gas is continuously pumped out of the enclosure via the open ends or apertures by the vacuum pump. The set of gas inlets may include a plurality of gas inlets, optionally together with respective mass flow controllers, thereby providing selection of different gases and/or gas mixtures in the enclosure. By mutually spacing apart the first gas inlet and a second gas inlet, for example relatively more proximal the entrance and the exit respectively of the enclosure, different gases may be introduced relatively more proximal the entrance and the exit respectively, for example to thermalise the ions and then react with the thermalised ions respectively or vice versa. Mulitpole RF ion guides are known. In one example, the first multipole RF ion guide comprises and/or is a quadrupole, a hexapole, an octapole, a decapole or a dodecapole i.e. a multipole of order 2, 3, 4, 5 or 6 respectively. In one example, the first multipole RF ion guide comprises round or hyperbolic rods. In one example, the first multipole RF ion guide comprises one or more electrodes for accelerating or decelerating the ions axially therethrough.

### First Ion Energy Filter

The ion guide assembly comprises the first ion energy filter disposed upstream of the CRC, to prevent ions having an ion energy below the first predetermined threshold from entering the CRC. It should be understood that the first ion energy filter and the CRC are arranged in tandem, such that ions having an ion energy of at least the first predetermined threshold from an ion source of the mass spectrometer are guided towards the CRC via the first ion energy filter. It should be understood that the first ion energy filter provides a potential energy barrier corresponding to and/or equal to the first predetermined threshold, thereby preventing ions having an axial kinetic energy therebelow from moving therepast. In use, such ions having an ion energy below the first predetermined threshold are removed from the chamber by pumping. It should be understood that the first ion energy filter is not enclosed, for example by the enclosure of the CRC, within the chamber, thereby improving pumping thereof. In one example, the first predetermined threshold is selectable, for example by a controller, thereby providing a selectable or tunable threshold and hence determining which ions are prevented from entering the CRC and which ions are admitted into the CRC. In one example, the first predetermined threshold is ramped, for example by a controller, for example as a function of mass-to-charge and/or an acceleration voltage, thereby providing a ramped threshold and hence determining which ions are prevented from entering the CRC and which ions are admitted into the CRC.

In one example, the first ion energy filter comprises a stacked ring RF ion guide and/or a multipole RF ion guide. Other ion guides are known. In one example, the first ion energy filter comprises a second multipole RF ion guide. In this way, ions are radially confined thereby while moving axially therethrough. In contrast, a DC only ion energy filter, such as a ring or Einzel-type lens, does not radial confine the ions. By radially confining the ions using a stacked ring RF ion guide and/or a multipole RF ion guide, susceptiblity to space charge effects that would be present with, for example, a ring or Einzel-type lens, is reduced. In this way, the first ion energy filter reduces, for example minimizes, both admittance of interfering ions due to a low filtering voltage (to minimize space charge effects) and loss of analyte beam due to higher filtering voltage (due to the slowed beam otherwise succumbing to space charge effects). In one example, the second multipole RF ion guide is electrically coupled to the first multipole RF ion guide of the CRC, for example corresponding rods thereof are mutually electrically coupled. In this way, the same RF power supply may be used for both the first multipole RF ion guide and the second multipole RF ion guide, as described below in more detail.

In one example, the second multipole RF ion guide has a set of DC electrodes interspersed between RF rods thereof. In one example, the second multipole RF ion guide comprises a set of DC electrodes such as rods, wherein the set of DC electrodes is interspersed between the rods of the second multipole RF ion guide. In this way, the first predetermined threshold is provided by DC voltages applied to the set of DC electrodes, which alters a mid-axis potential of the second multipole RF ion guide. In one example, mutually different DC voltages are applied to the set of DC electrodes, for example to provide ion steering, focusing and/or energy filtering. In one example, the first ion energy filter comprises an octupole providing the second multipole RF ion guide as a quadrupole RF ion guide having an interspersed quadrupole DC ion filter, in which RF potentials are applied to four alternate rods (for example even numbered rods) of the octupole and DC potentials are applied to the remaining four intermediate rods (for example odd numbered rods) of the octupole. In one example, the first ion energy filter comprises a dodecapole (12 rods) providing the second multipole RF ion guide as a hexapole RF ion guide having an interspersed hexapole DC ion filter, in which RF potentials are applied to six alternate rods (for example even numbered rods) of the dodecapole and DC potentials are applied to the remaining six intermediate rods (for example odd numbered rods) of the dodecapole. In one example, the first ion energy filter comprises a hexadecapole (16 rods) providing the second multipole RF ion guide as an octupole RF ion guide having an interspersed hexapole DC ion filter, in which RF potentials are applied to eight alternate rods (for example even numbered rods) of the hexadecapole and DC potentials are applied to the remaining eight intermediate rods (for example odd numbered rods) of the hexadecapole. In other words, additional electrodes are interspersed between the RF electrodes of the second multipole RF ion guide. For example, a dodecapole (12-pole) ion guide may be used, providing two interspersed hexapoles mutually axially rotated by 30°, with a hexapole RF voltage applied to every other rod (rods at 60 degree spacing) with the filtering DC voltage applied to the interspersed rods to alter the mid-axis potential of the multipole. Higher order multipoles are preferred for this, since the higher the order of the multipole, the flatter bottomed, and steeper sided the trapping potential, and thus the larger area at close to the filtering potential. A dodecapole is preferred, balancing ion energy filtering with complexity. It should be understood that the rods of the two interspersed hexapoles may be dissimilar. For example, the rods having the filtering DC voltage applied thereto may be wires, metallised edges of PCBs or metallised ceramics, for example. Additionally and/or alternatively, filtering DC voltages may be superimposed on the RF voltages. The rods may be relatively undersized compared with conventional ion guides, for example having diameters in a range from about 0.25 mm to 6.35 mm, preferably in a range from 0.5 mm to 3.5 mm. In this way, field shaping and/or gas flow are improved.

In one example, the first ion energy filter comprises an einzel lens including the second multipole RF ion guide. In one example, the first ion energy filter comprises a ring electrode disposed between two multipole RF ion guides, for example a pair of second multipole RF ion guides, as described above mutatis mutandis, wherein a filtering DC potential is applied to the ring electrode.

In one example, the first ion energy filter and the first multipole RF ion guide of the CRC are coaxial. In this way, ion flux is increased and/or construction facilitated. In one example, the first ion energy filter and the first multipole RF ion guide of the CRC are not coaxial (i.e. axially offset). In this way, streaming of neutrals and/or transmission of light from the ion source to the detector of the mass spectrometer may be reduced.

In one example, the first predetermined threshold is in a range from 0.1 V to 50 V (i.e. >0 V to several 10s V), preferably in a range from 0.5 V to 25 V. It should be understood that the first predetermined threshold correlates with an energy of the main beam (i.e. analyte ions of interest) relative to an energy of the interfering beam (i.e. interfering ions). It should be understood that the energy of the main beam and/or of the interfering beam may be a function of pressure in the ion source and hence the first predetermined threshold may be adjusted according to the pressure. In one example, the first predetermined threshold is controlled, for example by the controller, to achieve a predetermined figure of merit, such as a ration of an intensity of the main beam to the interfering beam of at least 5,000, preferably at least 10,000.

In one example, the first ion energy filter attenuates a flux of ions having an ion energy below the first predetermined threshold from entering the CRC by a factor of 2, 5, 10, 20, 50, 100, 200, 500, 1000, 2000, 5000, 10000 or more.

### Transfer Ion Guide

In one example, the ion guide assembly comprises a transfer ion guide disposed, for example coaxially, between the first ion energy filter and the CRC, for transferring ions downstream towards the CRC. In this way, ions having an ion energy of at least the first predetermined threshold are guided downstream from the first ion energy filter to the CRC.

In one example, the transfer ion guide comprises a stacked ring RF ion guide and/or a multipole RF ion guide. Other ion guides are known. In one example, the transfer ion guide comprises a third multipole RF ion guide. In this way, ions are radially confined thereby while moving axially therethrough. In one example, the third multipole RF ion guide is electrically coupled to the first multipole RF ion guide of the CRC and/or to the second multipole RF ion guide of the first ion energy filter, for example corresponding rods thereof are mutually electrically coupled. In this way, the same RF power supply may be used for the first multipole RF ion guide, the second multipole RF ion guide and/or the third multipole RF ion guide, as described below in more detail. In one example, the third multipole RF ion guide comprises and/or is a quadrupole, a hexapole, an octapole, a decapole or a dodecapole i.e. a multipole of order 2, 3, 4, 5 or 6 respectively. In one example, the third multipole RF ion guide comprises round or hyperbolic rods. In one example, the third multipole RF ion guide comprises one or more electrodes for accelerating or decelerating the ions axially therethrough. In one example, respective rods of the third multipole RF ion guide are mechanically coupled to and/or provided by corresponding rods of the second multipole RF ion guide of the first ion energy filter. For example, the corresponding rods of the second multipole RF ion guide of the first ion energy filter may be extended to protrude beyond a set of DC electrodes such as rods thereof, towards the CRC. In other words, the transfer ion guide may be provided by an RF-only region of the first ion energy filter.

In one example, the transfer ion guide is radially enclosed in the enclosure of the CRC. In this way, a length of the CRC is increased, thereby enhancing collisions and/or reactions therein, for example improving thermalisation of the ions having initially an ion energy of at least the first predetermined threshold. In one example, the transfer ion guide is radially enclosed in a separate or second enclosure (i.e. separate from the hence first enclosure of the CRC), having a second set of gas inlets, including a first gas inlet, therethrough. In this way, the transfer ion guide may provide a separate or second CRC, thereby enhancing and/or enabling different collisions and/or reactions therein, for example improving thermalisation of the ions having initially an ion energy of at least the first predetermined threshold, for example using different gases and/or at different pressures compared with the CRC.

### Entrance Ion Guide

In one example, the ion guide assembly comprises an entrance ion guide disposed, for example coaxially, upstream of the first ion energy filter for radially confining ions into the first ion energy filter. In this way, ions are guided downstream to the first ion energy filter, for example from the ion source.

In one example, the entrance ion guide comprises a stacked ring RF ion guide and/or a multipole RF ion guide. Other ion guides are known. In one example, the entrance ion guide comprises a fourth multipole RF ion guide. In this way, ions are radially confined thereby while moving axially therethrough. In one example, the fourth multipole RF ion guide is electrically coupled to the first multipole RF ion guide of the CRC, to the second multipole RF ion guide of the first ion energy filter and/or to the third multipole of the transfer ion guide, for example corresponding rods thereof are mutually electrically coupled. In this way, the same RF power supply may be used for the first multipole RF ion guide, the second multipole RF ion guide, the third multipole RF ion guide and/or the fourth multipole RF ion guide, as described below in more detail. In one example, the fourth multipole RF ion guide comprises and/or is a quadrupole, a hexapole, an octapole, a decapole or a dodecapole i.e. a multipole of order 2, 3, 4, 5 or 6 respectively. In one example, the fourth multipole RF ion guide comprises round or hyperbolic rods. In one example, the fourth multipole RF ion guide comprises one or more electrodes for accelerating or decelerating the ions axially therethrough. In one example, respective rods of the fourth multipole RF ion guide are mechanically coupled to and/or provided by corresponding rods of the second multipole RF ion guide of the first ion energy filter. For example, the corresponding rods of the second multipole RF ion guide of the first ion energy filter may be extended to protrude beyond a set of DC electrodes such as rods thereof, away from the CRC. In other words, the entrance ion guide may be provided by an RF-only region of the first ion energy filter.

It should be understood that the entrance ion guide is not enclosed, for example by the enclosure of the CRC, within the chamber, thereby improving pumping thereof.

In one example, a field radius of the entrance ion guide is greater than a field radius of the CRC, for example of a multipole RF ion guide thereof. In this way, the entrance ion guide may collect and guide a relatively higher ion flux, for example from the source such as from a skimmer cone of an ICP-MS, thereby increasing ion intensities (i.e. signals). In one example, a ratio of the field radius of the entrance ion guide to the field radius of the CRC is in a range from 1:1 to 10:1, preferably in a range from 1.1:1 to 5:1, more preferably in a ratio from 1.25:1 to 2.5:1, most preferably in a range from 1.5:1 to 2:1. Advantageously, by increasing the field radius of the entrance ion guide, increased beam may be admitted, a flatter filtering potential profile for a given order of multipole RF ion guide may be achieved (which improves sharpness of energy cut off), higher order ion guides may be included (which further flattens the potential) and/or the possibility to admit electrons to the guide through the interspersed rods is provided (as discussed below).

In one example, a field radius of the entrance ion guide is similar to, or the same as, a field radius of the first ion energy filter, for example wherein the field radius of the entrance ion guide is greater than a field radius of the first multipole RF ion guide of the CRC. In other words, in one example, the field radius of the first ion energy filter is similar to, or the same as, the field radius of the entrance ion guide, for example wherein the field radius of the entrance ion guide is greater than a field radius of the first multipole RF ion guide of the CRC. That is, the field radius of the first ion energy filter may be similarly larger than the field radius of the first multipole RF ion guide of the CRC, as described with respect to the entrance ion guide while the respective field radii of the first ion energy filter and the entrance ion guide may be similar or the same.

In one preferred example, the entrance ion guide and the transfer ion guide are provided by RF-only regions of the first ion energy filter, as described above. In one example, respective rods of the third multipole RF ion guide of the transfer ion guide and the fourth multipole RF ion guide of the entrance ion guide are mechanically coupled to and/or provided by corresponding rods of the second multipole RF ion guide of the first ion energy filter. In one example, the corresponding rods of the second multipole RF ion guide of the first ion energy filter are extended to protrude beyond a set of DC electrodes such as rods thereof, towards the CRC, to provide the third multipole RF ion guide (i.e. the transfer ion guide) and extended to protrude beyond the set of DC electrodes such as rods thereof, away from the CRC, to provide the fourth multipole RF ion guide (i.e. the entrance ion guide). In one example, the extensions either side of the set of DC electrodes such as rods thereof are symmetric or asymmetric.

### Ion Funnel

In one example, the ion guide assembly comprises an ion funnel disposed between the first ion energy filter and the CRC, for funnelling ions downstream towards the CRC, for example wherein a field radius of the first ion energy filter is greater than a field radius of the CRC. In this way, a relatively higher ion flux may be collected and guided, for example from the source such as from a skimmer cone of an ICP-MS, through the first ion energy filter and into the CRC, thereby increasing ion intensities (i.e. signals) of ions having initially an ion energy of at least the first predetermined threshold.

In one example, the ion funnel comprises a frustoconical stacked ring RF ion guide and/or a frustoconical multipole RF ion guide. Other ion funnels are known.

In one example, the ion funnel comprises a fifth multipole RF ion guide, wherein the fifth multipole RF ion guide comprises and/or is a frustoconical (i.e. tapered or fluted) multipole RF ion guide. The fifth multipole RF ion guide may be generally as described with respect to the third RF multipole ion guide of the transfer ion guide, mutatis mutandis. In one example, the ion guide assembly comprises a transfer ion guide and an ion funnel. In one example, the ion guide assembly comprises a transfer ion guide or an ion funnel i.e. the ion funnel may provide the transfer ion guide.

In one example, the ion funnel is radially enclosed in the enclosure of the CRC, for example as described with respect to the transfer ion guide.

In one example, the ion funnel is concentric, for example wherein the first multipole RF ion guide of the CRC and the first ion energy filter are coaxial. In this way, ion flux is increased and/or construction facilitated. In one example, the ion funnel is eccentric, for example wherein the first multipole RF ion guide of the CRC and the first ion energy filter are not coaxial (i.e. axially offset). In this way, streaming of neutrals and/or transmission of light from the ion source to the detector of the mass spectrometer may be reduced.

### Exit Ion Guide

In one example, the ion guide assembly comprises an exit ion guide, disposed, for example coaxially, downstream of the CRC. In this way, ions exiting the CRC are guided downstream therefrom, for example towards a mass analyzer. It should be understood that the exit ion guide is not enclosed, for example by the enclosure of the CRC, within the chamber, thereby improving pumping of the exit ion guide, for example to improve pumping of collision and/or reaction gases and/or neutrals exiting the CRC.

In one example, the exit ion guide comprises a stacked ring RF ion guide and/or a multipole RF ion guide. Other ion guides are known. In one example, the exit ion guide comprises a sixth multipole RF ion guide. The sixth multipole RF ion guide may be generally as described with respect to the first multipole RF ion guide of the CRC mutatis mutandis.

### Second Ion Energy Filter

In one example, the ion guide assembly comprises a second ion energy filter disposed, for example coaxially, between the first ion energy filter and the CRC, to prevent ions having an ion energy below a second predetermined threshold from exiting the CRC. In this way, thermalized ions, for example, are prevented from exiting the CRC, as described above with respect to the first ion energy filter. However, by providing a second ion energy filter, the second predetermined threshold may be different, for example selected independently, from the first predetermined threshold of the first ion energy filter, being relatively lower. Additionally and/or alternatively, the second ion energy filter may be disposed at or proximal the entrance of the CRC, for example spaced apart from the first ion energy filter by a transfer ion guide and/or an ion funnel. In this way, the second ion energy filter axially confines the thermalized ions downstream i.e. in the CRC and downstream thereof, thereby preventing the thermalized ions from backstreaming to the first ion guide, for example via the ion funnel and/or transfer ion guide. In one example, the second predetermined threshold is selectable, for example by a controller, thereby providing a selectable or tunable threshold and hence determining which thermalized ions are prevented from backstreaming from the CRC. In one example, the second predetermined threshold is ramped, for example by a controller, for example as a function of mass-to-charge and/or an acceleration voltage, thereby providing a ramped threshold and hence determining which ions are prevented from exiting the CRC. The second ion energy filter may be as described with respect to the first ion energy filter mutatis mutandis.

In one example, the second predetermined threshold is less than the first predetermined threshold. In one example, the second predetermined threshold is in a range from 0.1 V to 50 V (i.e. >0 V to several 10s V), preferably in a range from 0.5 V to 25 V i.e. generally as described with respect to the first predetermined threshold mutatis mutandis.

### Electron Source

In one example, the ion guide assembly comprises an electron source disposed upstream of the CRC, for example configured to emit electrons towards ions in the optional entrance ion guide, the first ion energy filter, the optional transfer ion guide and the optional ion funnel. In this way, argon ions (for example, originating from an ICP source) may be preferentially removed compared with ions of interest, since argon ions have a relatively higher electron affinity. In one example, the optional entrance ion guide, the first ion energy filter, the optional transfer ion guide and/or the optional ion funnel comprises a grounded electrode, or a plurality thereof, such as a rod, having a radial passageway, or a plurality thereof, therethrough for introduction of electrons. In this way, radial passageways may be disposed axially and/or circumferentially for introduction of electrons of electrons therethrough.

In one example, the electron source comprises and/or is a thermionic electron emitter. Typically, electrons are generated by thermionic emission from a cathode (i.e. the thermionic electron emitter), accelerated through the volume containing the gas molecules and collisions between the accelerated electrons and the atoms or molecules of the sample gas ionise a proportion thereof.

In one example, the thermionic electron emitter comprises a tungsten filament, for example a ribbon or a coiled wire, providing a cathode, wherein the electrons are emitted from an electron emitter surface thereof by passing an electrical heating current therethrough.

In one example, the electron source comprises an electron emitter cathode presenting a thermionic electron emitter surface and a heater element electrically isolated from the electron emitter cathode and arranged to be heated by an electrical current therein and to radiate heat to the electron emitter cathode sufficient to liberate electrons thermionically from said electron emitter surface. In this way, it is not necessary to pass an electrical heating current through the electron emitter surface. Instead, an electrical heating current is passed through a separate heating element which becomes heated to sufficient temperature e.g. incandescent hot, to radiate heat electromagnetically to the electron emitter cathode which is positioned adjacent to the heating element in order that it may absorb radiated heat energy and be heated remotely. Additionally and/or alternatively, instead, an electrical heating current is passed through a separate heating element which is thermally coupled to the electron emitter cathode that is in galvanic isolation from the heater. The thermal coupling medium may be e.g. alumina or any electrically insulating material that can conduct heat to the cathode. In one example, the heater is electrically isolated from the cathode by a small vacuum gap and the heating element is heated to incandescence, heating the electron emitter surface remotely by electromagnetic radiation. By removing the need to apply a voltage across a directly electrically heated electron emitter coil and instead passing an electrical hearing current through a separate heating element, problems associated with a potential gradient applied thereto and the resulting variation in emitted electron energy are avoided. This provides a more homogeneous electron energy which will provide greater control of the conditions affecting ionisation probability within the ion source, compared with a tungsten filament, for example.

The separation of the electrical heating aspect and the electron emission aspect of the electron source, enables the use of more optimal materials for thermionic electron emission which would not be suitable for heating electrically. Indeed, it has been found that electron emissions are increased by a factor of up to 5 to 10, as compared to electron emission rates from existing electrically heated electron sources operating over a comparable operation lifetime. Thus, whereas it is possible to increase electron emission rates from existing electrically heated electron sources, the great cost is that the electrically heated source will “burn out” very quickly. It will then need replacement within the mass spectrometer which will require a spectrometer to be opened up (vacuum lost) potentially causing months of down-time. High electron emission rates have been found to be achievable at significantly lower operating temperatures. This has a significant practical consequence because the reduced temperature reduces the presence of hydrocarbon volatiles within the vacuum of the mass spectrometer in use. For example, a flow rate of electrons into, or across, the ion guide assembly may exceed 500 μA, or preferably may exceed 750 uA, or more preferably may exceed 1 mA, or yet more preferably may exceed 2 mA. For example, an electron flow rate may be between 500 μA and 1mA, or may be between 1 mA and 20mA. These electron flow rates may be achievable when the temperature of the electron emitter cathode is preferably less than 2000° C., or more preferably less than 1500° C., or yet more preferably less than 1250° C., or even more preferably less than 1000° C., such as between 750° C. and 1000° C.

In one example, the electron emitter cathode is selected from: an oxide cathode; an I-cathode or Ba-dispenser cathode. In one example, the electron emitter cathode comprises a base part bearing a coating of thermionically emissive material presenting the electron emitter surface. When the electron emitter cathode comprises a base part bearing a coating, the coating may comprise a material selected from: an alkaline earth oxide; Osmium (Os); Ruthenium (Ru). The work function of the electron emitter surface, at a given temperature, may be reduced by the presence of the coating. For example, the coating material may provide a work function less than 1.9eV at a temperature not exceeding 1000° C. When no coating is used, the work function of the electron emitter surface may be greater than 1.9 eV at a temperature not exceeding 1000° C. Many other types of possible emitter material (e.g. Tungsten, W; Yttrium Oxide, e.g. Y₂O₃; Tantalum, Ta; Lanthanum/Boron compounds, e.g. LaBo) are available.

In one example, the base part comprises Tungsten or Nickel. In one example, the base part comprises a metallic material which separates the coating from the heater element.

Oxide cathodes are generally cheaper to produce. They may, for example, comprise a spray coating comprising (Ba, Sr, Ca)-carbonate particles or (Ba, Sr)-carbonate particles on a nickel cathode base part. This results in a relatively porous structure having about 75% porosity. The spray coating may include a dopant such as a rare earth oxide e.g. Europia or Yttria. These oxide cathodes offer good performance. However other types of cathode may be employed which may be more robust to being exposed to the atmosphere (e.g. when the mass spectrometer is opened).

So-called ‘I-cathodes’ or ‘Ba-dispenser’ may comprise a cathode base consisting of porous tungsten, e.g. with about 20% porosity, impregnated with a Barium compound. The base part may comprise tungsten impregnated with a compound comprising Barium Oxide (BaO). For example, the Tungsten may be impregnated with 4BaO.CaO.Al₂O₃, or other suitable material. In one example, the electron source comprises a sleeve surrounding the heater element, wherein the electron emitter surface resides proximal or at an end of the sleeve.

In one example, the heater element comprises a metallic filament coated with a coating comprising a metal oxide material.

Due to the improved rate of emission of electrons from the electron emitter cathode, for a given temperature of the heater element, it has been found that ample electron emission rates can be achieved at lower electrical input power levels as compared to existing electron emitter systems employing electrically heated electron emitter services/materials. For example, the electron emitter cathode may be operable to be heated by the heater element to a temperature not exceeding 2000° C. when the electrical power input to the heater element does not exceed 5 W. Preferably the electrical input power does not exceed 4 W, or more preferably does not exceed 3 W, yet more preferably does not exceed 2 W, or even more preferably does not exceed 1 W. The electrical power input to the heater element may be between about 0.5 W and about 1 W. These lower power input ratings enable the electron source to last longer, due to lower rates of cathode deterioration, and permit operation at lower temperatures with all of the attendant advantages flow from that. The lower rates of cathode deterioration provide improved uniformity of electron output improving consistency of the electron source. For example, the relatively high rates of deterioration in existing electron emitter cathodes, heated electrically, result in inconsistent cathode performance and mechanical instability as the cathode physically loses material (“burns out”) in use which often causes it to progressively change shape, especially in response to being heated, which has the effect of changing the electron output performance. In one example, the electron source comprises and/or is a field emission gun (FEG), such as a cold-cathode type, usually made of single crystal tungsten sharpened to a tip radius of about 100 nm, or a Schottky type. FEGs are also known as cold Field Electron Emitters and use large field gradients to generate free electrons without a heater. FEGs eliminate the need to stabilise temperature of a thermionic electron emitter.

### Mass Filter

In one example, the ion guide assembly comprises a mass filter, for example a quadrupole mass filter, disposed upstream of the CRC. In this way, ions of interest may be discriminated before the CRC.

### Mass Spectrometer

A second aspect provides a mass spectrometer comprising an ion guide assembly according to the first aspect.

In one example, the mass spectrometer comprises an ICP ion source or an electrospray ion source. Other ion sources are known. In one example, the mass spectrometer comprises a quadrupole mass analyser, a magnetic sector mass analyser, an electrostatic sector mass analyser, a time of flight mass analyser and/or an ion trap mass analyser. In one preferred example, the mass spectrometer comprises and/or is an ICP magnetic sector mass spectrometer.

### Method

A third aspect provides a method of controlling interferences in a mass spectrometer comprising a collision/reaction cell, CRC, the method comprising: preventing ions having an ion energy below a first predetermined threshold from entering the CRC.

The method may include any of the steps described with respect to the first aspect.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts an ion guide assembly according to an exemplary embodiment;

FIG. 2 schematically depicts an ion guide assembly according to an exemplary embodiment;

FIG. 3 schematically depicts an ion guide assembly according to an exemplary embodiment;

FIG. 4 schematically depicts an ion guide assembly according to an exemplary embodiment;

FIG. 5 schematically depicts an ion guide assembly according to an exemplary embodiment;

FIG. 6 schematically depicts an ion guide assembly according to an exemplary embodiment;

FIG. 7A schematically depicts an ion guide assembly according to an exemplary embodiment;

FIG. 7B schematically depicts an ion guide assembly according to an exemplary embodiment;

FIG. 8 schematically depicts an ion guide assembly according to an exemplary embodiment;

FIG. 9 schematically depicts an ion guide assembly according to an exemplary embodiment; and

FIG. 10 schematically depicts a method according to an exemplary embodiment.

### DETAILED DESCRIPTION OF THE DRAWINGS

Generally, like reference signs indicate like features, description of which is not repeated, for brevity. It should be understood that the features of the ion guide assemblies described with respect to the drawings may be combined and/or alternatives thereto provided, as described with respect to the first aspect.

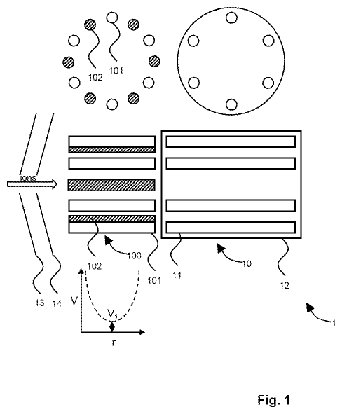

FIG. 1 schematically depicts an ion guide assembly 1 according to an exemplary embodiment. Particularly, FIG. 1 schematically depicts an axial cross-sectional view of the ion guide assembly 1 (middle, generally) together with radial cross-sectional views of features thereof (above, generally) and corresponding voltage curves (below, generally).

The ion guide assembly 1 is for a mass spectrometer. The ion guide assembly comprises: a collision/reaction cell, CRC, 10 comprising an enclosure 12 having a first multipole RF ion guide 11 enclosed radially therein and a set of gas inlets (not shown), including a first gas inlet, therethrough; and a first ion energy filter 100 disposed upstream of the CRC, to prevent ions having an ion energy below a first predetermined threshold Vi from entering the CRC 10.

Also shown is a sample cone 12 (typically grounded) and a skimmer cone 13 (typically grounded), upstream of the first ion energy filter 100. Ions are transferred from an ion source (not shown) via the sample cone 12 and the skimmer cone 13 into the first ion energy filter 100. Ions having an ion energy below the first predetermined threshold Vi are prevented from entering the CRC 10 by the first ion energy filter 100. Ions having an ion energy of at least the first predetermined threshold Vi are not prevented from entering the CRC 10 by the first ion energy filter 100.

In this example, the first ion energy filter 100 comprises a second multipole RF ion guide 101. In this example, the first ion energy filter 100 comprises a dodecapole providing the second multipole RF ion guide 101 as a hexapole RF ion guide 101 having an interspersed hexapole DC ion filter 102, in which RF potentials are applied to six alternate rods (not filled) of the dodecapole and DC potentials are applied to the remaining six intermediate rods (hatched) of the dodecapole. In this example, the second multipole RF ion 101 guide comprises round rods. In this example, the first ion energy filter 100 and the first multipole RF ion guide 11 of the CRC 10 are coaxial.

In this example, a field radius of the second multipole RF ion guide 101 of the first ion energy filter 100 is equal to a field radius of the first multipole RF ion guide 11 of the CRC 10.

In this example, the first predetermined threshold Vi is in a range from 0.1 V to 50 V.

In this example, the first ion energy filter 100 attenuates a flux of ions having an ion energy below the first predetermined threshold Vi from entering the CRC 10 by a factor of 2, 5, 10, 20, 50, 100, 200, 500, 1000, 2000, 5000, 10000 or more.

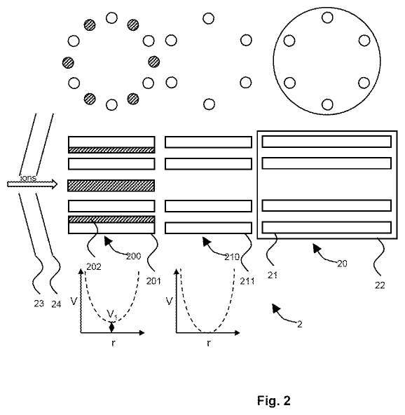

FIG. 2 schematically depicts an ion guide assembly 2 according to an exemplary embodiment. Particularly, FIG. 2 schematically depicts an axial cross-sectional view of the ion guide assembly 2 together with radial cross-sectional views of features thereof and corresponding voltage curves.

The ion guide assembly 2 is generally as described with respect to the ion guide assembly 1 and description of which is not repeated, for brevity.

In contrast to the ion guide assembly 1, in this example, the ion guide assembly 2 comprises a transfer ion guide 210 disposed coaxially between the first ion energy filter 200 and the CRC 20, for transferring ions downstream towards the CRC 20. In this example, the transfer ion guide 210 comprises a third multipole RF ion guide 211. In this example, the third multipole RF ion guide 211 is electrically coupled to the second multipole RF ion guide 201 of the first ion energy filter 200, for example corresponding rods thereof are mutually electrically coupled. In this example, the third multipole RF ion guide 211 is a hexapole. In this example, the third multipole RF ion 211 guide comprises round rods.

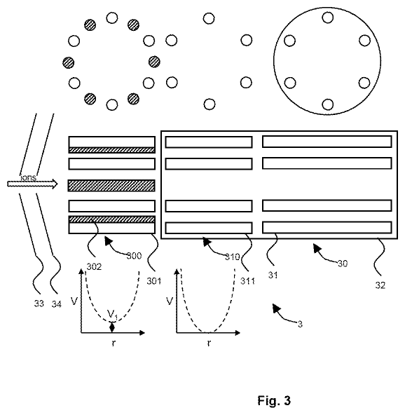

FIG. 3 schematically depicts an ion guide assembly 3 according to an exemplary embodiment. Particularly, FIG. 3 schematically depicts an axial cross-sectional view of the ion guide assembly 3 together with radial cross-sectional views of features thereof and corresponding voltage curves.

The ion guide assembly 3 is generally as described with respect to the ion guide assembly 2 and description of which is not repeated, for brevity.

In contrast to the ion guide assembly 2, in this example, the transfer ion guide 310 is radially enclosed in the enclosure 32 of the CRC 30. It should be understood that radially enclosing the transfer ion guide in the enclosure of the CRC may be applied generally to the embodiments described herein, optionally enclosing also ion guides (if present) between the transfer ion guide and the CRC.

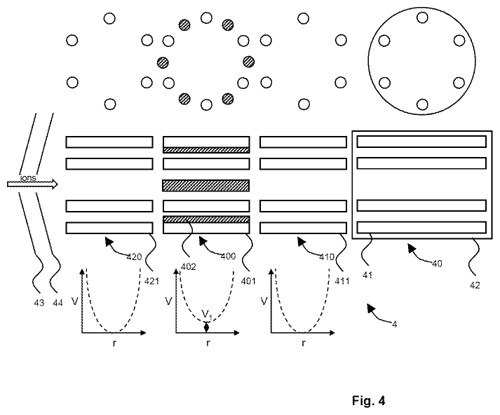

FIG. 4 schematically depicts an ion guide assembly 4 according to an exemplary embodiment. Particularly, FIG. 4 schematically depicts an axial cross-sectional view of the ion guide assembly 4 together with radial cross-sectional views of features thereof and corresponding voltage curves.

The ion guide assembly 4 is generally as described with respect to the ion guide assembly 2 and description of which is not repeated, for brevity.

In contrast to the ion guide assembly 2, in this example, the ion guide assembly 4 comprises an entrance ion guide 420 disposed coaxially upstream of the first ion energy filter 400 for radially confining ions into the first ion energy filter 400. In this example, the entrance ion guide 420 comprises a fourth multipole RF ion guide 421. In this example, the fourth multipole RF ion guide 421 is electrically coupled to the second multipole RF ion guide 401 of the first ion energy filter 400, for example corresponding rods thereof are mutually electrically coupled. In this example, the fourth multipole RF ion guide 421 is a hexapole. In this example, the fourth multipole RF ion 421 guide comprises round rods.

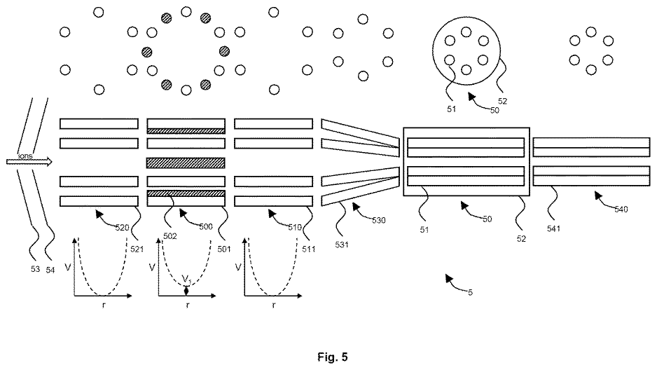

FIG. 5 schematically depicts an ion guide assembly 5 according to an exemplary embodiment. Particularly, FIG. 5 schematically depicts an axial cross-sectional view of the ion guide assembly 5 together with radial cross-sectional views of features thereof and corresponding voltage curves.

The ion guide assembly 5 is generally as described with respect to the ion guide assembly 4 and description of which is not repeated, for brevity.

In contrast to the ion guide assembly 4, in this example, a field radius of the fourth multipole RF ion guide 521 of the entrance ion guide 520 is greater than a field radius of the first multipole RF ion guide 51 of the CRC 50, by a ratio in a range from 1.25:1 to 2.5:1. In this example, the respective field radii of the second multipole RF ion guide 501, the third multipole RF ion guide 511 and the fourth multipole RF ion guide 521 are equal. In this example, the ion guide assembly 5 comprises an ion funnel 530 disposed between the first ion energy filter 500 and the CRC 50, particularly between the transfer ion guide 510 and the CRC 50. In this example, the ion funnel 530 comprises a fifth multipole RF ion guide 531, wherein the fifth multipole RF ion guide 531 is a frustoconical multipole RF ion guide. In this example, the ion funnel 530 is concentric.

In this example, the ion guide 5 assembly comprises an exit ion guide 540, disposed coaxially downstream of the CRC 50. In this example, the exit ion guide 540 comprises a sixth multipole RF ion guide 541.

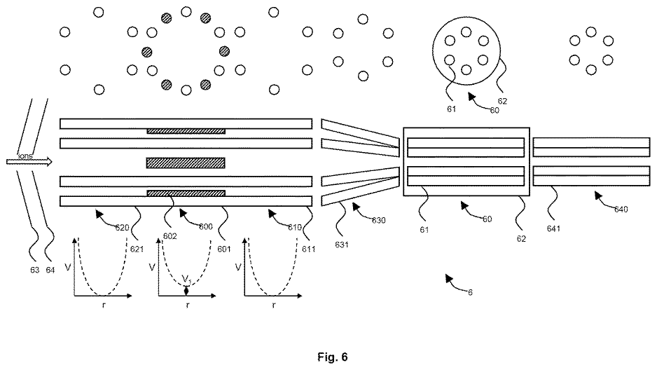

FIG. 6 schematically depicts an ion guide assembly 6 according to an exemplary embodiment. Particularly, FIG. 6 schematically depicts an axial cross-sectional view of the ion guide assembly 6 together with radial cross-sectional views of features thereof and corresponding voltage curves.

The ion guide assembly 6 is generally as described with respect to the ion guide assembly 5 and description of which is not repeated, for brevity.

In contrast to the ion guide assembly 5, in this example, the entrance ion guide 620 and the transfer ion guide 610 are provided by RF-only regions of the first ion energy filter 600. In this example, the corresponding rods of the second multipole RF ion guide 601 of the first ion energy filter 600 are extended to protrude beyond the set of DC electrodes 602 thereof, towards the CRC 60, to provide the third multipole RF ion guide 611 and extended to protrude beyond the set of DC electrodes thereof, away from the CRC 60, to provide the fourth multipole RF ion guide 621. The extensions either side of the set of DC electrodes 602 is symmetric.

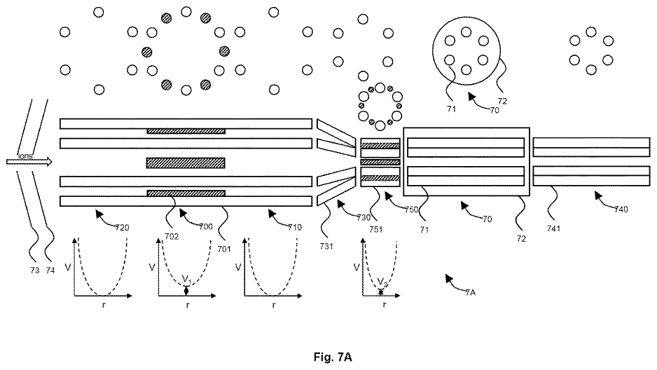

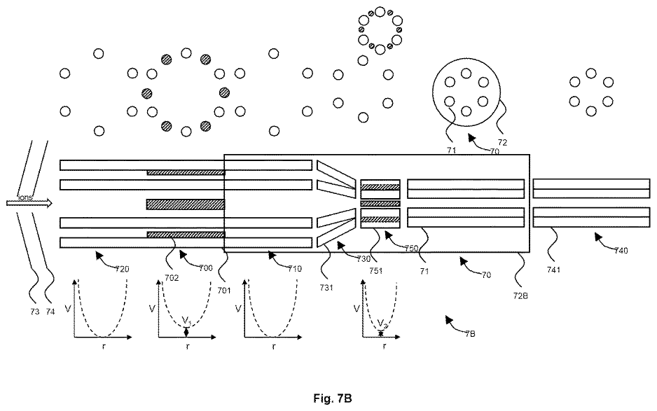

FIG. 7A schematically depicts an ion guide assembly 7A according to an exemplary embodiment. Particularly, FIG. 7A schematically depicts an axial cross-sectional view of the ion guide assembly 7A together with radial cross-sectional views of features thereof and corresponding voltage curves.

The ion guide assembly 7A is generally as described with respect to the ion guide assembly 6 and description of which is not repeated, for brevity.

In contrast to the ion guide assembly 6, in this example, the ion guide assembly 7A comprises a second ion energy filter 750 disposed coaxially between the first ion energy filter 700 and the CRC 70, to prevent ions having an ion energy below a second predetermined threshold V2 from exiting the CRC 70. In this example, the second ion energy filter 750 is disposed at or proximal the entrance of the CRC 70, spaced apart from the first ion energy filter 700 by the transfer ion guide 710 and the ion funnel 730. The second ion energy filter 750 is generally as described with respect to the first ion energy filter 700 mutatis mutandis. In contrast to the first ion energy filter 700, a field radius of the seventh multipole RF ion guide 751 of the second ion energy filter 750 is equal to a field radius of the first multipole RF ion guide 71 of the CRC 70.

In this example, the second predetermined threshold is in a range from 0.1 V to 50 V.

FIG. 7B schematically depicts an ion guide assembly 7B according to an exemplary embodiment. Particularly, FIG. 7B schematically depicts an axial cross-sectional view of the ion guide assembly 7B together with radial cross-sectional views of features thereof and corresponding voltage curves.

The ion guide assembly 7B is generally as described with respect to the ion guide assembly 7A and description of which is not repeated, for brevity.

In contrast to the ion guide assembly 7A, in this example, the transfer ion guide 710, the ion funnel 730 and the second ion energy filter 750 are radially enclosed in the enclosure 72B of the CRC 70, generally as described with respect to the ion guide assembly 3. In this way, transfer of the beam between the relatively larger region of the transfer ion guide 710 and the relatively smaller region of the first multipole RF ion guide 71 of the CRC 70 (i.e. resulting from the field radius of the fourth multipole RF ion guide 721, provided by the corresponding rods of the second multipole RF ion guide 701 of the first ion energy filter 700, of the entrance ion guide 720 being greater than a field radius of the first multipole RF ion guide 71 of the CRC 70) due to the reduction of the radial extent of the beam during thermalizing is improved. In other words, this has the effect of reducing the radial spread of the ions in this initial pressured region, where the ion beam will be partially thermalised, aiding in transmission to the smaller radius region.

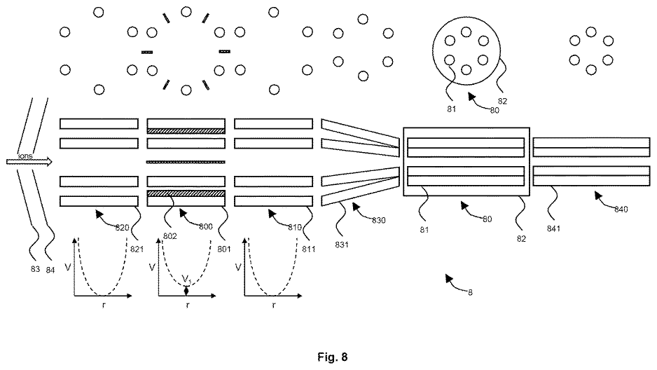

FIG. 8 schematically depicts an ion guide assembly 8 according to an exemplary embodiment. Particularly, FIG. 8 schematically depicts an axial cross-sectional view of the ion guide assembly 8 together with radial cross-sectional views of features thereof and corresponding voltage curves.

The ion guide assembly 8 is generally as described with respect to the ion guide assembly 5 and description of which is not repeated, for brevity.

In contrast to the ion guide assembly 5, in this example, interspersed hexapole DC ion filter 802 is provided by metallised edges of PCBs (hatched) c.f. six intermediate rods (hatched) of the dodecapole.

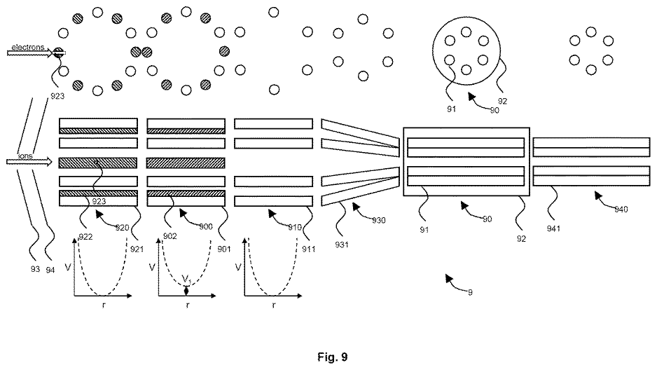

FIG. 9 schematically depicts an ion guide assembly 9 according to an exemplary embodiment. Particularly, FIG. 9 schematically depicts an axial cross-sectional view of the ion guide assembly 9 together with radial cross-sectional views of features thereof and corresponding voltage curves.

The ion guide assembly 9 is generally as described with respect to the ion guide assembly 5 and description of which is not repeated, for brevity.

In contrast to the ion guide assembly 5, in this example, the ion guide assembly 9 comprises an electron source (not shown) disposed upstream of the CRC 90, configured to emit electrons towards ions in the entrance ion guide 820. In this example, the entrance ion guide 920 comprises a plurality of grounded electrodes, provided as grounded hexapole rods 922, having a radial passageway 923, therethrough for introduction of electrons.

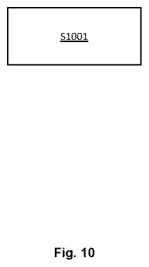

FIG. 10 schematically depicts a method according to an exemplary embodiment.

The method is of controlling interferences in a mass spectrometer comprising a collision/reaction cell, CRC.

At S1001, the method comprises preventing ions having an ion energy below a first predetermined threshold from entering the CRC.

The method may include any of the steps described herein.

Although a preferred embodiment has been shown and described, it will be appreciated by those skilled in the art that various changes and modifications might be made without departing from the scope of the invention, as defined in the appended claims and as described above.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. An ion guide assembly for a mass spectrometer, comprising:
a collision/reaction cell, CRC, comprising an enclosure having a first multipole RF ion guide enclosed radially therein and a set of gas inlets, including a first gas inlet, therethrough; and
a first ion energy filter disposed upstream of the CRC, to prevent ions having an ion energy below a first predetermined threshold from entering the CRC;
wherein the first ion energy filter comprises a second multipole RF ion guide.

2. The ion guide assembly according to claim 1, wherein the second multipole RF ion guide has a set of DC electrodes interspersed between RF rods thereof or wherein the first ion energy filter comprises an einzel lens including the second multipole RF ion guide.

3. The ion guide assembly according to claim 1, comprising a transfer ion guide disposed between the first ion energy filter and the CRC, for transferring ions downstream towards the CRC.

4. The ion guide assembly according to claim 3, wherein the transfer ion guide comprises a third multipole RF ion guide.

5. The ion guide assembly according to claim 3, wherein the transfer ion guide is radially enclosed in the enclosure of the CRC.

6. The ion guide assembly according to claim 1, comprising an entrance ion guide disposed upstream of the first ion energy filter for radially confining ions into the first ion energy filter.

7. The ion guide assembly according to claim 6, wherein the entrance ion guide comprises a fourth multipole RF ion guide.

8. The ion guide assembly according to claim 6, wherein a field radius of the entrance ion guide is greater than a field radius of the CRC.

9. The ion guide assembly according to claim 8, wherein the field radius of the entrance ion guide is similar to, or the same as, a field radius of the first ion energy filter.

10. The ion guide assembly according claim 9, comprising an ion funnel disposed between the first ion energy filter and the CRC, for funnelling ions downstream towards the CRC.

11. The ion guide assembly according to claim 10, wherein the ion funnel comprises a fifth multipole RF ion guide, wherein the fifth multipole RF ion guide comprises and/or is a frustoconical multipole RF ion guide.

12. The ion guide assembly according to claim 10, wherein the ion funnel is radially enclosed in the enclosure of the CRC.

13. The ion guide assembly according to claim 1, comprising an exit ion guide, disposed downstream of the CRC.

14. The ion guide assembly according to claim 13, wherein the exit ion guide comprises a sixth multipole RF ion guide.

15. The ion guide assembly according to claim 1, wherein the first ion energy filter and the first multipole RF ion guide of the CRC are coaxial.

16. The ion guide assembly according to claim 1, comprising a second ion energy filter disposed between the first ion energy filter and the CRC, to prevent ions having an ion energy below a second predetermined threshold from exiting the CRC.

17. The ion guide assembly according to claim 1, comprising an electron source disposed upstream of the CRC.

18. The ion guide assembly according to claim 1, comprising a mass filter disposed upstream of the CRC.

19. A mass spectrometer comprising an ion guide assembly according to claim 1.

20. A method of controlling interferences in a mass spectrometer comprising a collision/reaction cell, CRC, the method comprising:
preventing ions having an ion energy below a first predetermined threshold from entering the CRC, using a multipole RF ion guide disposed upstream of the CRC.
